(19) United States
(12) Patent Application Publication
(10) Pub. No.: US 2021/0140553 A1
(43) Pub. Date: May 13, 2021

(54) PRESSURE-BALANCED RELIEF VALVE

(71) Applicant: Emcara Gas Development Inc., Guelph (CA)

(72) Inventors: Erick GIROUARD, Guelph (CA); Amir AHMADZADEGAN, Waterloo (CA)

(21) Appl. No.: 16/622,758

(22) PCT Filed: Jun. 13, 2018
(86) PCT No.: PCT/CA2018/050709

§ 371 Date: Dec. 13, 2019

Related U.S. Application Data
(60) Provisional application No. 62/518,663, filed on Jun. 13, 2017.

(51) Int. Cl. F16K 17/38; F16K 31/00; F16K 39/04; F17C 13/04

(52) U.S. Cl. CPC F16K 17/38; F16K 31/002; F17C 13/04; F16K 39/04; F16K 31/003

(57) ABSTRACT

There is provided a valve apparatus comprising a body including an inlet, an outlet, and a fluid passage extending from the inlet to the outlet, a closure member displaceable, relative to the fluid passage, from a closed position to an open position for effecting fluid communication between the inlet and the outlet, a retainer for retaining the closure member in the closed position, and an actuator including a stimulus responder for receiving a predetermined stimulus and effecting release of the closure member from retention by the retainer in response to the receiving of a predetermined stimulus. The closure member, the retainer, and the stimulus responder are co-operatively configured such that: while there is an absence of receiving of a predetermined stimulus by the stimulus responder, the closure member is retained by the retainer in the closed position, and while the closure member is being retained by the retainer, in response to receiving of a predetermined stimulus by the stimulus responder, the closure member becomes released from the retention by the retainer.

### CROSS-REFERENCE TO RELATED APPLICATION

This application claims benefit of and priority to U.S. Provisional Patent Application No. 62/518,663 filed Jun. 13, 2017, the contents of which are incorporated herein by reference.

### FIELD

The present disclosure relates to valves for venting fluid from a vessel, and, in particular, to temperature activated valves for venting fluid from a pressurized tank.

### BACKGROUND

Pressure relief valves using temperature activated triggers, such as shape memory alloys, rely on a pressure differential between an inlet in fluid communication with a pressurized tank and an outlet that is at atmospheric pressure to actuate the release mechanism. Thermally actuated valves include those described and illustrated in Applicant's U.S. Pat. Nos. 9,121,521 and 9,097,358, herein incorporated by reference in their entireties. Flow rates of such valves depend on a cross-sectional area of a valve passage. The internal forces on the valve will be affected by the cross-sectional area of the valve passage and the operating pressure. In high pressure or high flow rate applications, the internal forces on a valve may be so high that the performance of the valve is affected.

### BRIEF DESCRIPTION OF THE DRAWINGS

The preferred embodiments will now be described with reference to the following accompanying drawings:

FIG. 1 shows a schematic view of a valve connected to a pressurized vessel according to an embodiment of the invention;

FIG. 2 shows a cross-sectional view of a valve in a non-venting mode according to an embodiment of the vessel; and

FIG. 3 shows a cross-sectional view of a valve in a venting mode according to an embodiment of the vessel.

### DETAILED DESCRIPTION

Referring to FIGS. 1 to 3, there is provided an embodiment of a valve apparatus 200 for attachment, either directly or indirectly, to an opening (such as a port) of a container such as, for example, a vessel or tank containing liquids or gases held under pressure such as a tank 100.

The valve apparatus 200 includes a body 201. The body 201 defines an inlet port 202, an outlet port 204, a fluid passage 206, and a closure member receiving passage 209. The inlet port 202 is configured for fluid coupling to a tank 100 for receiving gaseous material from the tank 100. The outlet port 204 is configured for venting the received gaseous material to the immediate environment (for example, the atmosphere). For example, the material of the body 20 is metallic. Suitable metallic materials include brass, aluminum, or stainless steel.

The valve apparatus 200 further includes a closure member 208 for closing fluid communication between the inlet port 202 and the outlet port 204. The closure member 208 is moveable (e.g. slideably moveable) between a closed position and an open position within the closure member receiving passage 209. The discharge fluid passage 206 extends from the inlet port 202 to the outlet port 204 for effecting fluid communication between the inlet and outlet ports 202, 204, when the closure member 208 is disposed in the open position. In the closed position, fluid communication between the inlet port 202 and the outlet port 204 is sealed or substantially sealed. In the open position, fluid communication is effected between the inlet port 202 and the outlet port 204.

In some embodiments, for example, the closure member 208 includes a closure member body 208A which carries one or more o-rings, for effecting sealing engagement of the closure member 208 to the body 201 while the closure member 208 is disposed in the closed position such that fluid is prevented from flowing from the inlet port 202 to the outlet port 204. The closure member body 208A is made from one or more of a variety of materials including metal. For example, a suitable metal is steel. The one or more o-rings may be made from elastomeric material.

The valve apparatus 200 further includes a trigger mechanism. In some embodiments, the trigger mechanism is an actuator 210. The actuator 210 is provided for effecting a change in condition to the closure member 208, in response to receiving of a predetermined stimulus, such that the closure member 208 becomes displaceable from the closed position to the open position. The actuator 210 is configured to assume a change in its condition, from a non-actuating position to an actuating position, in response to receiving of a predetermined stimulus. In some embodiments, for example, the predetermined stimulus includes heat energy, such that the valve apparatus 200 is a thermally actuated valve. Exemplary thermally actuated valves are described and illustrated in U.S. Pat. Nos. 9,121,521 and 9,097,358, which are hereby incorporated by reference.

When the valve apparatus 200 is a thermally actuated valve, in some of these embodiments, for example, the actuator 210 includes a temperature responsive portion 210A, and the predetermined stimulus is heat energy that is sufficient to increase the temperature of the temperature responsive portion 210A to above a predetermined minimum temperature. In some embodiments, for example, the receiving of heat energy by the actuator 210 effects a change in shape of the heated portion of the temperature responsive portion 210A such that a change in dimension of the temperature-responsive portion 210A is effected. In some of these embodiments, for example, the temperature responsive portion 210A includes a longitudinal axis, and the change in shape includes a reduction in length of the temperature responsive portion 210A along its longitudinal axis. In this respect, in some embodiments, for example, the temperature responsive portion 210A includes shape memory alloy material.

A fire or other heat source which can effect displacement of the actuator 210 can also effect heating of the tank 100 to which the valve apparatus 200 is attached. In such cases, in some embodiments, for example, the displacement of the actuator 208 is effected by the heat before the heating of the tank 100 effects the failure of the tank 100 such that gaseous material within the tank 100 is vented remotely from the fire. “Failure” of the tank 100 occurs when the integrity of the tank 100 is compromised, such as by, for example, rupturing, breaking or melting. By enabling such venting of the gaseous material within the tank 100 before the failure of the tank 100, the risk of explosion, effected by heating of the gaseous material stored within the tank 100, is mitigated.

Additionally, the apparatus 200 further includes a retainer 210B. The retainer 210B is retaining the closure member 208 in the closed position.

The closure member 208, the retainer 210B, and the actuator 210 are co-operatively configured such that the closure member 208 is retained by the retainer 210B in the closed position, while: (i) the retainer 210B and the actuator 210 are disposed in a stimulus communicating relationship, and (ii) there is an absence of receiving of a predetermined stimulus by the actuator 210. In some embodiments, for example, the stimulus communicating relationship includes coupling of the retainer 210B and the actuator 210. In some embodiments, for example, the absence of receiving of a predetermined stimulus by the actuator 210 includes circumstances where the temperature responsive portion 210A is disposed below the predetermined minimum temperature.

The closure member 208, the retainer 210B, and the actuator 210 are co-operatively configured such that while: (i) the retainer 210B is retaining the closure member 208 in the closed position, and (ii) the retainer 210B and the actuator 210 are disposed in a stimulus communicating relationship, in response to receiving of a predetermined stimulus by the actuator 210, the closure member 208 becomes released from the retention by the retainer 210B. In some of these embodiments, for example, the release from the retention is effected in response to the temperature responsive portion 210A becoming disposed at or above the predetermined minimum temperature.

In this respect, in some embodiments, for example, while the actuator 210 is disposed in the actuated position, and the closure member 208 is released from retention by the retainer 210B, the closure member 208 is displaceable from the closed position to the open position in response to a sufficient pressure differential being provided between the inlet 202 and the outlet 204 (i.e. while the actuator 210 is disposed in the actuated position, the closure member 208 is displaced from the closed position to the open position when the pressure differential between the inlet 202 and the outlet 204 exceeds a predetermined minimum pressure differential). In some of these embodiments, for example, the inlet 202 is disposed in fluid communication with the tank 100, and is, thereby, exposed to fluid pressure within the tank 100, and the outlet 204 is disposed in fluid communication with the atmosphere and is, thereby, exposed to atmospheric pressure, such that, so long as the fluid pressure within the tank 100 exceeds atmospheric pressure by a predetermined minimum pressure differential, and so long as the actuator 210 is disposed in the actuated position, the closure member 208 will become displaced from the closed position to the open position.

In some embodiments, for example, the actuator 210 includes a movable portion 210C. The movable portion 210C is coupled to the retainer 210B, such that the release of the closure member 208 from the retention in the closed position by the retainer 210B is effected by movement of the movable portion 210C. The body 201 includes an actuator-receiving passage 211 for receiving the movable portion 201C during movement of the movable portion 210C. In some embodiments, for example, in response to the receiving of heat energy by the actuator 210, the heated temperature responsive portion 210A effects exertion of a tensile force, thereby effecting the movement of the moveable portion 210C such that the actuator 210 becomes disposed in the actuated position. In some embodiments (not shown), for example, the moveable portion 210C includes the retainer 2108, such that the retainer 210B translates with the moveable portion 210C.

In some embodiments, for example, the moveable portion 210C is separate from the retainer 210B. In this respect, in some embodiments, for example, the actuator 210 includes a retainer actuator 210X that is separate from the retainer 210B. In some embodiments, for example, the retainer actuator 210X translates with the movable portion 210C. In some embodiments, for example, the retainer actuator 210X is displaceable, relative to the retainer 210B, from a retaining position to a released position, in response to the receiving of heat energy and upon the disposition of the temperature responsive portion 210 at a temperature that is at or above the predetermined minimum temperature. While disposed in the retaining position (see FIG. 1), the retainer actuator 210X is retaining the retainer 2108 in a position relative to the closure member 208 such that the retainer 210B retains the closure member 208 in the closed position. In some of these embodiments, for example, while disposed in the retaining position, the retainer actuator 210X is interfering with a releasing displacement of the retainer 210B relative to the closure member 208 that would effect the release of the closure member 208 from the retention by the retainer 210B. While the retainer actuator 210X is disposed in the released position (see FIG. 2), the retainer 210B is released from retention by the retainer actuator 210X such that the retainer 2108 is displaceable relative to the closure member 208 for effecting the release of the retention of the closure member 208 in the closed position. In this respect, while the retainer actuator 210X is disposed in the released position, the retention of the closure member 208, in the closed position, by the retainer 2108, is defeatable.

In those embodiments where the retainer actuator 210X is separate from the retainer 210B, in some of these embodiments, for example, and referring to FIGS. 1 and 2, the retainer 210B includes a free ball 210BB. In some embodiments, for example, the material of construction of the ball 210BB is steel.

In some embodiments, for example, the retention of the closure member 208 in the closed position by the ball 210BB is effected by interference to displacement of the closure member, from the closed position to the open position, by the ball 210BB. In some embodiments, for example, the interference is effected by disposition of the ball 210BB within a ball seat 208G (such as, for example, a recess or a cut-out) of the closure member 208. Co-operatively, in effecting this interference, the retainer actuator 210X and a ball-retaining surface 201A of the body 201 prevents, or substantially prevents, release of the ball 210BB from its disposition within the ball seat 208G, while the retainer actuator 210X is disposed in the retaining position.

In this respect, the ball-retaining surface 201A, prevents, or substantially prevents, displacement of the ball 210BB, relative to the body 201, that is being urged by a pressure differential established between the inlet 202 and the outlet 202, that is urging the displacement of the closure member 208 from the closed position to the open position. The force (arising from a pressure differential, such as a pressure differential that exceeds the predetermined minimum pressure differential) that is urging the displacement of the closure member 208 from the closed position to the open position, in combination with the above-described opposition provided by the ball-retaining surface 201A, results in a net force that urges release of the ball 210BB from the ball seat 208G, and, while disposed in the retaining position, the retainer actuator 210X opposes such force and retains the ball 210BB within the ball seat 208G (in the illustrated embodiment, the retainer actuator 210X prevents, or substantially prevents, movement of the ball 210BB along an axis that is orthogonal to the axis along which the closure member 208 is movable to the open position). When the retainer actuator 210X becomes disposed in the released position, such opposition is absent, permitting the pressure differential to liberate the ball 210BB from the ball seat 208G, and thereby releasing the closure member 208 from retention by the ball 210BB and enabling its displacement to the open position, in response to application of a pressure differential between the inlet 202 and the outlet 204 that exceeds the minimum predetermined pressure differential, as explained above.

While the retainer actuator 210X is disposed in the retaining position, and gaseous material is disposed within the tank 100 such that a pressure differential, exceeding the predetermined minimum pressure differential, is urging displacement of the closure member 208 to the open position, force is transmitted by the closure member 208 to the ball 210BB, and the ball 210BB transmits most of the force being applied to the closure member 208 onto the body 201, while transmitting a smaller force onto the actuator 210. By having the retainer 210B separated from the temperature responsive portion 210A, such as is the case with the above-described embodiments with the ball 210BB, less frictional resistance is impartable to the moveable portion 210C when it is being displaced by tensile forces resulting from the receiving of heat by the temperature responsive portion 210A, compared to when the retainer 210B is integral with the moveable portion 210C. This allows for greater flexibility in the choice of materials for the temperature responsive portion 210A, which may, for example, be a wire (for example, comprising a shape memory alloy).

In some embodiments, for example, the actuator 210 further includes a retainable portion configured for retention of the actuator 210 relative to a source of pressurized fluid pressurized fluid material. In some embodiments the retainable portion includes a fixedly couplable portion 210D. The fixedly couplable portion 210D is configured for being fixed, or substantially fixed, relative to the body 201 such that, while the fixedly couplable portion 210D is fixed, or substantially fixed, relative to the body 201, in response to the receiving of sufficient heat energy by the actuator 210, the moveable portion 210C is displaced relative to the fixedly couplable portion 210D such that the spacing between the moveable portion 210C and the fixedly couplable portion 210D is reduced.

In some embodiments, for example, the fixing, or substantial fixing, of the spatial disposition of the fixedly couplable portion 210D, relative to the body 201, is effected by connection between the body 201 and a connector 224. For example, the connector 224 is made from metallic material, and suitable metallic materials includes copper, stainless steel, brass or aluminum, or a combination of said materials. The connector 224 is stiffer than the moveable portion 210C of the actuator 210. In some embodiments, for example, the connector 224 is of a tubular form, extending from the body 201, and attached to the actuator 210 with a retaining assembly 226. The retaining assembly 226 includes a washer 226A and a crimp 226B. The washer 226A is disposed in an interference relationship with the connector 224 such that the washer 226A is fixed, or substantially fixed, relative to the connector 224. The actuator 226 extends through a hole within the washer 226A and its displacement through the hole is restricted by the crimp 226B which is clamped onto an end 210E of the actuator 210. While the crimp 226B is clamped onto the end 210E of the actuator 210, the hole of the washer 226A and the crimp 226B are co-operatively configured such that passage of the crimp 226B through the hole, in the direction of the retainer 210B of the actuator 210, is restricted, with effect that passage of the end 210E of the actuator 210 towards the retainer 210B is restricted and thereby effecting fixing, or substantial fixing, of the end 210E of actuator 210 relative to the body 201.

In some embodiments, for example, the retaining assembly 226 is closed or covered by a cap 229 which is connected to the connector 224. Fastening of the connector 224 to the retaining assembly 226 is then effected with a nut 235, which is threaded to the cap 229, and which forces a ferrule 234 to pinch the connector 224. In this respect, during assembly, the nut 235 and the ferrule 234 are slid over the end of the connector 224 which is desired to be fastened to the cap 229. The connector 224 is then pushed into an aperture provided within the cap 229. The nut 235 is then tightened until the ferrule 234 squeezes the connector 224. For example, the cap 229 is made using metallic material, such as brass or stainless steel. In some embodiments, for example, the cap 229 functions to cover the assembly of the retaining assembly 226 to, amongst other things, prevent, or mitigate, material ingress or physical damage.

In some embodiments, for example, the fixing, or substantial fixing, of the spatial disposition of the fixedly couplable portion 210D, relative to the body 201, is effected by an indirect connection to the body 201. In this respect, in some embodiments, for example, the connector 224 effects attachment of the fixedly couplable portion 210D to the tank 100 to which the body 201 is connected. In some of these embodiments, for example, the connector 224 is a strap, band or other fastener.

It is understood that a portion of the actuator 210 is not required to be spatially fixed, or substantially fixed, relative to the body 201, in order for the actuation of the closure member 208 to be effected in response to receiving of heat by the temperature responsive portion 210A. However, by effecting the fixing, or substantial fixing, of the spatial disposition of the fixedly couplable portion 210D, relative to the body 201, displacement of the moveable portion 210C, effected in response to a change in dimension of the temperature responsive portion 210 (that is effected by the receiving of sufficient heat energy by the actuator 210), is more pronounced (such as, for example, a greater displacement of the moveable portion 210C is realized) than the case where a portion of the actuator 210 is not spatially fixed, or substantially fixed, relative to the body 201.

In some embodiments, for example, the actuator 210 is disposed within a sleeve 240 that is disposed within the connector 224. The sleeve 240 functions to reduce friction between the actuator 210 and the connector 224, during movement of the actuator 210 through the connector 224, in parallel with the displacement of the retainer 2108. In some embodiments, for example, the sleeve 240 is disposed in interference fit relationship with the connector 224. In some embodiments, for example, the sleeve 240 is made from a plastic, such as polytetrafluoroethylene. In some embodiments, for example, the sleeve 240 is made from TEFLON™.

In some embodiments, for example, the temperature responsive portion 210A is disposed at least between the fixedly couplable portion 210D and the moveable portion 210C. retainer 2108. In some of these embodiments, for example, the moveable portion 210C includes at least a portion of the temperature responsive portion 210A.

In those embodiments where the material of the temperature responsive portion 210A is a shape memory alloy, in some of these embodiments, for example, the temperature, at which the temperature responsive portion 210A assumes a change in shape, is modified by a shape changing temperature modifier 212. In some embodiments, the shape changing temperature modifier 212 includes a biasing member 216. The biasing member 216, the temperature responsive portion 210A, and the fixedly couplable portion 210D are co-operatively configured such that, while the fixedly couplable portion 210D is fixed relative to the body 201, the biasing member 216 exerts a tensile force on the temperature responsive portion 210A, thereby effecting a change to the shape changing characteristics of the temperature responsive portion 210A.

In some embodiments, for example, the actuator 210 includes a housing 218, such that the movable portion 210C includes a housing 218 that is coupled to the temperature responsive portion 210A. The temperature responsive portion 210A is pinched between a pin 214 and the housing 218, such that the temperature responsive portion 210A is coupled to the housing 218. The housing 218 contains the biasing member 216 and is disposed in force transmission communication with the biasing member 216 such that the biasing member 216 is exerting a tensile force to the temperature responsive portion 210A. For example, the biasing member 216 is a resilient member, such as a spring. For example, the spring is a coil spring made from steel. The biasing member 216 is coupled to the body 201 with a retainer 220. The retainer 220 is fastened to the body 201. For example, the retainer 220 is in the form of a nut which threads into complementary threads provided on an external surface of the body 201, thereby retaining the biasing member 216 relative to the body 201. For example, the material of the retainer 220 is metallic. Suitable metallic materials include brass, aluminum, or stainless steel. For example, the material of the pin 214 is a metal, such as steel. In some embodiments, for example, the attachment of the connector 224 to the body 201 is effected by connection of the connector to the retainer 220.

The biasing member 216, the housing 218, and the fixedly couplable portion 210D are co-operatively configured such that, while the fixedly couplable portion 210D is fixed relative to the body 201, the biasing member 216 presses against the housing 218, urging the housing 218 away from the fixedly couplable portion 210D. The retainer 220 includes a passage 222 which receives the temperature responsive portion 210A so as to facilitate the coupling of the temperature responsive portion 210A to the shape changing temperature modifier 212 and to facilitate movement of the moveable portion 210C (which, in this case, includes the temperature responsive portion 210C). In this respect, while the fixedly couplable portion 210D is fixedly coupled to the tank 100, by pressing against the housing 218, and urging the housing 218 away from the fixedly couplable portion 210D, the biasing member 216 effects application of a tensile force to the temperature responsive portion 210A such that the shape changing temperature characteristics of the temperature responsive portion 210A are modified.

The closure member 208, the retainer 210B, and the temperature responsive portion 210 are co-operatively configured such that:
the closure member 208 is retained by the retainer 210B in the closed position, while the temperature of the temperature response portion 210A is not exceeding (i.e. is disposed at or below) the predetermined minimum temperature; and
while the closure member 208 is being retained by the retainer 210B, in response to receiving of a predetermined stimulus by the temperature responsive portion 210A, the closure member 208 becomes released from the retention by the retainer 210B.

Also, the inlet 202, the outlet 204, and the closure member 208 are co-operatively configured such that: while the closure member 208 is disposed in the closed position and released from the retention by the retainer 210B, and the inlet 202 is disposed in fluid communication with a source of pressurized fluid:
(i) the pressurized fluid is communicated to a first surface fraction 208D of the closure member 208 for urging of displacement of the closure member 208 to the open position; and
(ii) the pressurized fluid is communicated to a second surface fraction 208E of the closure member 208 with effect that the displacement, being urged by the pressurized fluid communicated to the first surface fraction 208D, is opposed.

While the closure member 208 is released from the retention by the retainer 210B, the communication of the pressurized fluid to both of the first surface fraction 208D and the second surface fraction 208E results in application of a net force that effects displacement of the closure member 208 to the open position, while the closure member 208. In this respect, the first surface fraction 208D and the second fluid surface fraction 208E are co-operatively configured such that, while fluid pressure is communicated from the inlet 202 to both of the first compartment 250 and the second compartment 252, the closure member is urged to the open position.

In some embodiments, for example, the body 201 defines a first compartment 250 within which the pressurized fluid is communicated to the first surface fraction 208D, and also defines a second compartment 252 within which the pressurized fluid communicated to the second surface fraction 208E. In some embodiments, for example, a closure member passage 208F extends through the closure member 208 such that fluid communication is effected between the first and second compartments 250, 252 and, therefore, the surface fractions 208D, 208E. In some embodiments, for example, the inlet 202, the first compartment 250, the passage 208F, and the second compartment 252 are co-operatively configured such that the inlet 202 fluidly communicates with the second compartment 252 via the first compartment 250 and the passage 208F. In some embodiments, for example, the first and second compartments 250, 252 are determined by the disposition of the closure member 208 relative to the passage 209. In some embodiments, for example, the inlet, the first compartment 250, and the second compartment 252 are co-operatively configured such that pressure within the first compartment 250 is equal to, or about equal to, the pressure within the second compartment 252.

In some embodiments, for example, fluid pressure communicated from the inlet 202 to the first compartment 250 acts on the first surface fraction 208D and exerts a closure member opening force. In some embodiments, fluid pressure communicated form the inlet 202 to the second compartment 252 acts on the second surface fraction 208E exerts a closure member opening balancing force. The closure member opening force is opposed by the closure member opening balancing force. In some embodiments, for example, the cross-sectional area of the first fluid surface fraction 208D exceeds the cross-sectional area of the second surface fraction 208E. In some embodiments, for example, the ratio of the cross-sectional area of the first fluid surface fraction 208D to the cross-sectional area of the second surface fraction 208E is at least 1.05, such as, for example, at least 1.1, such as, for example, at least 1.15:1, such as, for example, at least 1.2:1.

In some embodiments, for example, the closure member 208 and the body 201 are sealingly engaged, or substantially sealingly engaged, such that, in the closed position, the flow of fluid, between the closure member 208 and the body 201, from the first compartment 250 and to the outlet port 206, is prevented or substantially prevented. In some embodiments, the prevention or substantial prevention of fluid flow, between the closure member 208 and the body 201, from the first compartment 250 to the outlet port 206, is effected by a first sealing member. In some embodiments, the closure member 208 carries the first sealing member. In some embodiments, the first sealing member is an o-ring 208B. The o-ring 208B may be made from an elastomeric material. Suitable elastomeric materials for use in o-ring 208B include, for example, natural rubbers, synthetic rubbers and thermoplastics.

In some embodiments, for example, the closure member 208 and the body 201 are sealingly engaged, or substantially sealing engaged, such that, in the closed position, the flow of fluid, between the closure member 208 and the body 201, from the second compartment 252 and to the outlet port 206, is prevented or substantially prevented. In some embodiments, the prevention or substantial prevention of fluid flow, between the closure member 208 and the body 201, from the second compartment 252 to the outlet port 206, is effected by a second sealing member. In some embodiments, the closure member 208 carries the second sealing member. In some embodiments, the second sealing member is an o-ring 208C. The o-ring 208C may be made from an elastomeric material. Suitable elastomeric materials for use in o-ring 208C include, for example, natural rubbers, synthetic rubbers and thermoplastics.

By partially balancing the fluid pressure, communicated from the inlet 202, acting upon the closure member 208, forces acting on the closure member 208, and transmitted to the movable portion 210C of the actuator via the closure member 208 and the retainer 210B (such as, for example, the ball 210BB), are managed such that excessive force (e.g. frictional force) need not be overcome in order to move the movable portion 210C for effecting the release of the closure member 208 from retention by the retainer 210B.

When large forces are acting on the closure member 208, the ball seat 208G in the closure member may have a profile that is complementary to the shape of the ball, and, in some embodiments, for example, this is for mitigating inadvertent release of the ball 210BB, resulting in inadvertent opening of the closure member 208. However, when the ball seat 208G is complementary to a portion of the ball 210BB, variations in the positioning of the ball 210BB relative to the ball seat 208G or the imperfections in the profile of ball seat 208G, may result in imprecise control of the contact angle. High contact angles between the closure member 208 and the ball 210BB, may result in high friction forces between the ball 210BB and the body 201, thereby impeding the displacement of the ball 210BB from the ball seat 208G when the retainer actuator 210X releases the ball 210BB. In contrast, low contact angles between the closure member 208 and the ball 210BB may result in higher frictional resistance imparted to the moveable portion 210C. By reducing the force on the closure member 208, a simplified geometry for the ball seat 208G can be used. A simplified geometry is better able to control the contact angle between the ball 210BB and the body 201. In some embodiments, the ball seat 208G has a frusto-conical, a frusto-pyramidal, or a prismatic trapezoidal profile.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A valve apparatus comprising:
a body including an inlet, an outlet, and a fluid passage extending from the inlet to the outlet;
a closure member displaceable, relative to the fluid passage, from a closed position to an open position for effecting fluid communication between the inlet and the outlet;
a retainer for retaining the closure member in the closed position; and
an actuator including a stimulus responder for receiving a predetermined stimulus and effecting release of the closure member from retention by the retainer in response to the receiving of a predetermined stimulus;
wherein the closure member, the retainer, and the stimulus responder are co-operatively configured such that:
while there is an absence of receiving of a predetermined stimulus by the stimulus responder, the closure member is retained by the retainer in the closed position; and
while the closure member is being retained by the retainer, in response to receiving of a predetermined stimulus by the stimulus responder, the closure member becomes released from the retention by the retainer;
wherein the closure member and the fluid passage are co-operatively configured such that:
while the closure member is disposed in the closed position and released from the retention by the retainer, and the inlet is disposed in fluid communication with a source of pressurized fluid:
(i) the pressurized fluid is communicated to a first surface fraction of the closure member for urging of displacement of the closure member to the open position; and
(ii) the pressurized fluid is communicated to a second surface fraction of the closure member with effect that the displacement, being urged by the pressurized fluid communicated to the first surface fraction, is opposed;
with effect that a resultant unbalanced force effects displacement of the closure member to the open position.

2. The valve apparatus as claimed in claim 1; wherein:
the body defines a first compartment within which the communication of the pressurized fluid to the first surface fraction is effected, and also defines a second compartment within which the communication of the pressurized fluid to the first surface fraction is effected;
the closure member includes a closure member passage;
the inlet, the first compartment, the closure member passage, and the second compartment are co-operatively configured such that the inlet fluidly communicates with the second compartment via the first compartment and the closure member passage.

3. The valve apparatus as claimed in claim 1 or 2; wherein:
the cross-sectional surface area of the first surface fraction exceeds the cross-sectional surface area of the second surface fraction.

4. The valve apparatus as claimed in claim 1; wherein:
the retainer, and the stimulus responder are co-operatively configured such that:
while there is an absence of receiving of a predetermined stimulus by the stimulus responder, the retainer is retained by the stimulus responder for preventing displacement of the closure member from the closed position to the open position; and
while the retainer is being retained by the stimulus responder, in response to receiving of a predetermined stimulus by the stimulus responder, the retainer becomes released from the retention by the stimulus responder such that the retention of the closure member by the retainer becomes defeatable.

5. The valve apparatus as claimed in claim 14; wherein:
the inlet, the closure member, and the retainer are co-operatively configured such that, while the retainer is released from the retention by the stimulus responder, defeating of the retention of the closure member by the retainer is effectible in response to communication of pressurized fluid to the inlet.

6. The valve apparatus as claimed in claim 1;
wherein the predetermined stimulus includes heat.

7. The valve as claimed in claim 16; wherein:
the stimulus responder includes a temperature responsive portion; and
the material of construction of the temperature responsive portion includes shaped memory alloy material.
